(19) United States
(12) Patent Application Publication
(10) Pub. No.: US 2005/0039400 A1
(43) Pub. Date: Feb. 24, 2005

(54) Hydrogen production process from carbonaceous materials using membrane gasifier

(76) Inventors: Francis Lau, Darien, IL (US); Shain-Jer Doong, Kildeer, IL (US)

Correspondence Address: MARK E. FEJER;GAS TECHNOLOGY INSTITUTE, 1700 SOUTH MOUNTAIN PROSPECT ROAD, DES PLAINES, IL, 60018, US

(21) Appl. No.: 10/780,384

(22) Filed: Feb. 17, 2004

Related U.S. Application Data
(60) Provisional application No. 60/497,285, filed on Aug. 22, 2003.

(51) Int. Cl. B01J 7/00

(52) U.S. Cl. 48/198.3; 48/61; 48/127.9; 48/128; 48/198.7

(57) ABSTRACT

A method and apparatus for producing hydrogen from carbonaceous materials using a hydrogen-selective permeation membrane incorporated into a carbonaceous material reactor, as a result of which, hydrogen production rate from the reactor is increased, downstream gas cleaning and purification units of conventional systems are eliminated or substantially reduced in size, and the thermal efficiency of producing hydrogen from carbon-containing materials is increased and its production cost is reduced.

### BACKGROUND OF THE INVENTION

1. Field of the Invention

This invention relates to a method and apparatus for producing hydrogen from carbonaceous materials including, but not limited to, natural gas, coal, biomass and petroleum coke. More particularly, this invention relates to a method and apparatus for producing hydrogen by conversion of carbonaceous materials using a hydrogen-selective permeation membrane incorporated into a gasification and/or gas phase reactor. Exemplary of gas phase reactors considered to be within the scope of this invention include, but are not limited to, water-gas shift reactors and fuel reformers, e.g. catalytic steam reformers, partial oxidation reformers and autothermal reformers. As a result, hydrogen production rates from the reactor are increased over conventional systems, the downstream gas cleaning and purification units are eliminated or substantially reduced in size, the thermal efficiency of producing hydrogen from carbon-containing materials is increased and its production cost is reduced.

2. Description of Related Art

Hydrogen can be produced from carbonaceous materials such as coal, biomass, petroleum coke and the like by reacting the materials with oxygen and steam in a gasification device at elevated temperature conditions, typically in the range of about 700° to about 2000° C. Hydrogen can also be produced, for example, by catalytic steam reforming in which a fuel to be reformed, such as natural gas, is mixed with steam in the presence of a base metal catalyst. The pressures at which the gasification can be effected are in the range of 1 to 200 atm. The effluent from the gasifier, after removing any solid constituents present therein, typically contains H₂, CO, CO₂, CH₄, H₂O, H₂S and other contaminants. This stream then goes through a water shift reaction, where CO and H₂O are reacted to form a mixture containing mostly H₂ and CO₂. Sulfur and other contaminants are removed before the hydrogen is separated and purified in a PSA (pressure swing adsorption) unit or other similar H₂ separation means. If necessary, CO₂ can be removed prior to the PSA unit to obtain a CO₂-enriched stream and increase the hydrogen recovery in the PSA unit. A simplified flow diagram for this process is shown in FIG. 1. This process generally has about a 50-60% thermal efficiency, which is defined as the energy recovered from the hydrogen product divided by the energy input in the feed. Depending on the feedstock price, the cost of producing hydrogen from this process is currently not competitive to steam reforming from natural gas. Thus, there is a need to develop a more efficient process to reduce the hydrogen production cost from solid carbonaceous materials.

Under the ideal conditions where the carbon in the feed is completely converted in a gasifier, the chemical reactions can be characterized by the following reactions:
CH₄+H₂O=CO+3H₂
CO₂+CH₄=2CO+2H₂
If hydrogen is removed while it is being produced in the gasifier, the equilibrium will be shifted toward the right hand sides of the two reactions above. As a result, more hydrogen and CO will be produced and less CH₄ will be present in the product gas. The net effect is an increase in the production of hydrogen from the gasifier.

### SUMMARY OF THE INVENTION

Accordingly, it is one object of this invention to provide a method and apparatus for producing hydrogen from carbonaceous materials.

It is another object of this invention to provide a method and apparatus for increasing the thermal efficiency of hydrogen production from gasification of carbonaceous materials compared to conventional methods and apparatuses.

It is a further object of this invention to provide a method and apparatus for gasifying carbonaceous materials to produce hydrogen in which gas cleaning and purification systems typically disposed downstream of the gasifier are substantially reduced in size compared to conventional systems or altogether eliminated.

It is still a further object of this invention to provide a method and apparatus for producing hydrogen by gasifying carbonaceous materials in which the hydrogen production rate is increased over the hydrogen production rate of conventional systems.

It is yet a further object of this invention to provide a method and apparatus for producing hydrogen by reforming carbonaceous materials.

These and other objects are addressed by a method and apparatus for conversion of carbonaceous material in which substantially pure hydrogen gas is removed substantially immediately upon production from the reactor vessel by means of a permeable hydrogen-selective membrane disposed within the reactor vessel. That is, hydrogen is separated from the product gas mixture by the membrane as the hydrogen is being produced in the reactor vessel. The remaining non-permeate gas mixture from the reactor vessel can be further processed in a membrane shift reactor to convert carbon monoxide and water to hydrogen. Alternatively, the non-permeate gas stream can be separated via conventional separation techniques such as amine absorber and PSA (pressure swing adsorption) into multiple products including H₂, CO and CO₂.

### BRIEF DESCRIPTION OF THE DRAWINGS

These and other objects and features of this invention will be better understood from the following detailed description taken in conjunction with the drawings wherein:

FIG. 1 is a process diagram showing a conventional gasification process for producing hydrogen;

FIG. 2 is a process diagram showing a gasification process for producing hydrogen employing a permeable hydrogen-selective membrane in accordance with one embodiment of the method and apparatus of this invention;

FIG. 3 is a process diagram showing a gasification process for producing hydrogen employing a permeable hydrogen-selective membrane in accordance with another embodiment of the method and apparatus of this invention;

FIG. 4 is a schematic diagram of a gasification reactor in accordance with one embodiment of this invention;

FIG. 5 is a schematic diagram of a membrane module for use in a gasification reactor in accordance with one embodiment of this invention;

FIG. 6 is an enlarged cross-sectional view of a membrane tube of the membrane module shown in FIG. 5 in accordance with one embodiment of this invention; and

FIG. 7 is a schematic diagram of a gas phase reactor in accordance with one embodiment of this invention.

### DETAILED DESCRIPTION OF THE PRESENTLY PREFERRED EMBODIMENTS

The invention disclosed and claimed herein is a method and apparatus for conversion and/or transformation of a carbonaceous material in which substantially pure hydrogen gas produced in the conversion/transformation process is separated from the product gas mixture generated by the process as it is produced using a permeable hydrogen-selective membrane disposed within the conversion/transformation vessel. Although described herein primarily in the context of a gasification process, the invention disclosed and claimed herein is equally applicable to other conversion processes such as water-gas shift and fuel reforming process, and such processes are deemed to be within the scope of this invention.

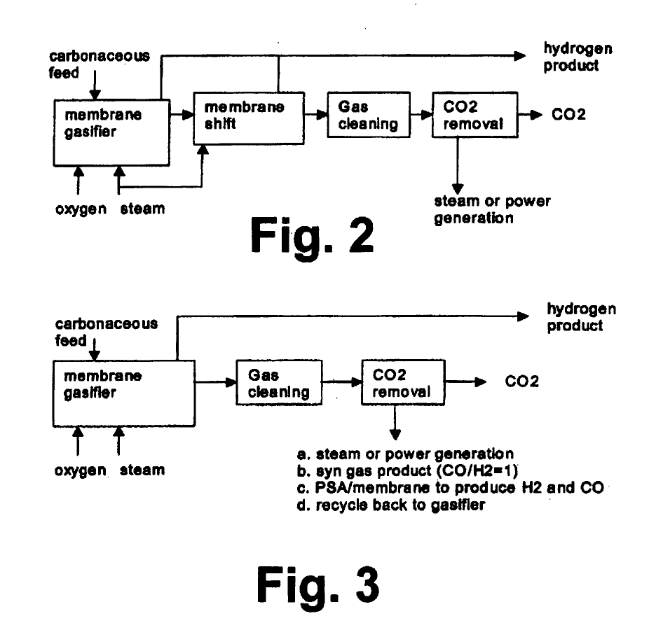

In accordance with one particularly preferred embodiment, the invention disclosed and claimed herein is a method and apparatus for gasification of carbonaceous material in which substantially pure hydrogen gas is separated from the product gas mixture of a gasification process as it is produced using a permeable hydrogen-selective membrane disposed within the gasification reactor. FIG. 2 shows a process for producing hydrogen from carbonaceous materials in accordance with one embodiment of this invention in which the gasification reactor and shift reactor of the conventional system are replaced by a gasification reactor and shift reactor comprising a permeable hydrogen-selective membrane. In this way, hydrogen formed in the gasification reactor and hydrogen present in the shift reactor is immediately removed from the gasification product gas stream, that is prior to the gas cleaning step, thereby simplifying the gas processing steps downstream of the shift reactor.

FIG. 3 shows yet another embodiment of the process of this invention in which the carbonaceous material is gasified in a gasification reactor comprising a permeable hydrogen-selective membrane and the hydrogen generated therein is immediately separated from the gasification product gas stream. The non-permeate stream is sent directly to an amine absorber or other suitable means for removing CO₂. The remaining portion of the gas stream, which contains primarily H₂ and CO, may be used in a variety of ways as indicated in FIG. 3, namely, steam or power generation, sale as a synthesis gas product, transmission to a PSA unit and/or recycle back to the gasification reactor. This embodiment has the particular benefit of obviating the need for a shift reactor altogether.

Any membrane material that is stable at the gasification temperature and that preferentially allows hydrogen over other gas constituents to permeate through the membrane is suitable for use in the method and apparatus of this invention. Preferred materials for producing suitable membranes are selected from the group consisting of Pd, Pd—Ag alloys, Pd—Cu alloys, ceramic materials of the perovskite type, composites of Pd and ceramic materials, and combinations thereof. Other preferred materials suitable for use in the method and apparatus of this invention are porous inorganic membranes such as alumina, molecular sieve zeolite and the like, in which gas separation relies on the relative size of the molecules under the “Knudsen flow” regime.

Palladium-based membranes have been used for decades to produce very pure hydrogen for commercial use, especially in the semiconductor industry. However, the highest operating temperature reported for these types of membranes is about 600° C. In addition, palladium alloys having improved permeability, stability and strength have been developed. Included in these alloys are metals selected from the group consisting of Cu, Ag, Ta, Nb and the like.

In accordance with one particularly preferred embodiment of this invention, a permeable hydrogen-selective membrane suitable for operating at temperatures above about 900° C., such as is encountered in a typical gasification reactor, is made from a ceramic material of perovskite oxide having the formula
A₁₋ₓA′ₓB_{1-y}B′_{y}O_{3-z}
where A is selected from the group consisting of Ba, Sr, Ca and Mg, A′ is selected from the group consisting of La, Pr, Nd, Gd, and Yb, B and B′ are selected from the group consisting of Ce, Nd, Sm, Eu, Gd, Tm, Yb and Y, O is oxygen, x and y are numbers between 0 and 1, and z is a number sufficient to neutralize the charge in the mixed metal oxide. These types of materials possess the unique property of conducting both protons and electrons. Under a gradient of chemical potentials or partial pressures of hydrogen across the membrane, only hydrogen can “diffuse” or migrate through the membrane.

The perovskite material is known to have proton conductive characteristics. However, for use in membrane separation applications without external electrical circuitry, it is necessary that this material also be electronically conductive. In accordance with one embodiment of this invention, the above-described ceramic material is combined with another metal to form a two-phase conductor. Thus, proton conductivity is provided through the ceramic phase and electron conductivity is provided primarily through the metallic phase (continuous). Any metal which is electronically conductive and which is able to withstand the harsh environment of a gasification reactor may be employed. Such metals need not be proton conductive. Preferred metals are selected from the group consisting of Ni, Pd, Pt, and combinations thereof.

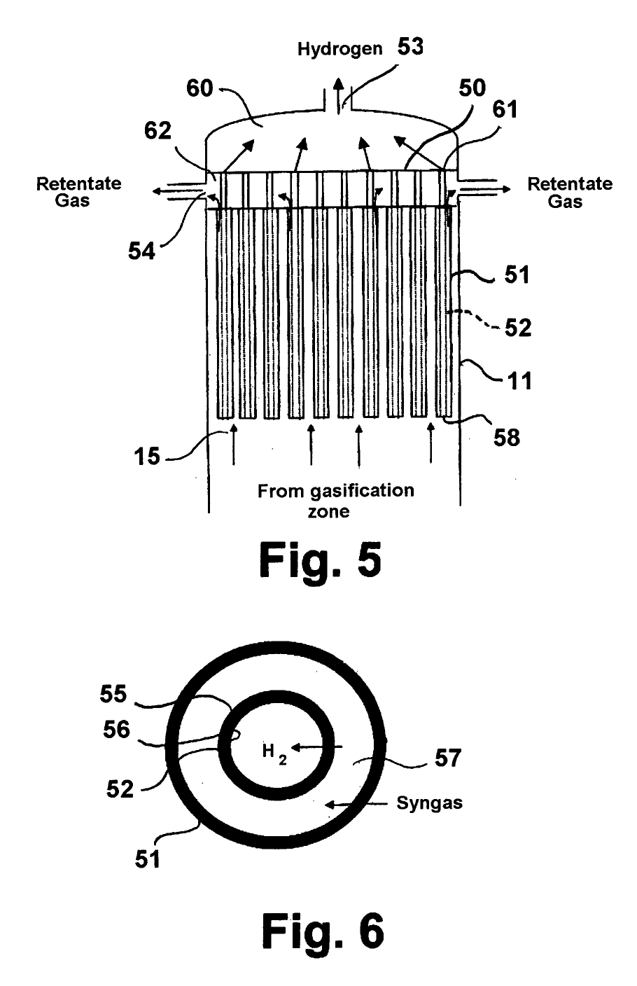

The membrane materials can be fabricated in tube or sheet form. A membrane module, which comprises a plurality of tubes or sheets, is then placed within the gasifier reactor. Such membrane module in accordance with one embodiment of this invention, described in detail herein below, is shown in FIG. 5. Preferably, a protective sheath enclosing the membrane module is provided to prevent solid particles that may be present from damaging the membrane while still allowing all the gas molecules to go through.

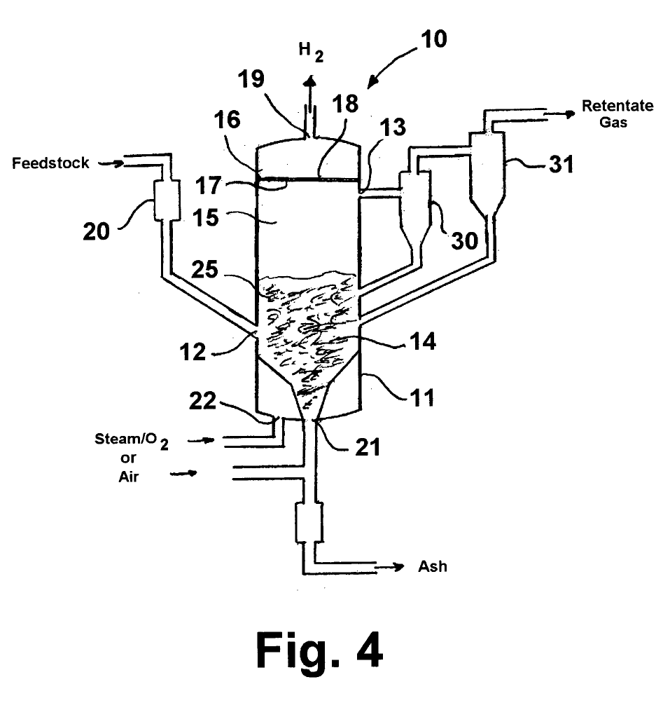

FIG. 4 is a schematic diagram showing a gasification system 10 employing a permeable hydrogen-selective membrane in accordance with one embodiment of this invention. As shown, the gasification system 10 comprises a gasification reactor vessel 11 having a carbonaceous feed material inlet 12, an hydrogen-rich gas outlet 19 and a retentate gas outlet 13. Gasification reactor vessel 11 comprises a gasification zone 14 disposed within a lower region thereof and a product gas zone 15 disposed within an upper region thereof, the upper region containing gasification product gas. In accordance with one preferred embodiment of this invention, gasification zone 14 comprises a particle bed 25 which may be either a fixed particle bed or, preferably, a fluidized particle bed. Disposed within product gas zone 15 is at least one permeable hydrogen-selective membrane 16 having a first side 17 in contact with the gasification product gas and an opposite second side 18 in contact with an hydrogen-rich gas.

In operation, a carbonaceous material feedstock is introduced by way of feedstock lockhopper 20, or other suitable means, through carbonaceous material inlet 12 into gasification zone 14 comprising a fluidized bed within which the carbonaceous material feedstock reacts with steam and oxygen, introduced into the gasification reaction vessel 11 through inlets 22, at temperatures in the range of about 600° to about 2000° C., preferably in the range of about 800° to 1200° C., to form a gasification product gas and ash. The temperature of the fluidized bed depends on the type of solid fuel. The operating pressure is in the range of about 1 to about 200 atm, preferably in the range of about 10 to about 80 atm. The steam and oxygen or air are introduced into the fluidized bed through distributors (not shown) in the bottom region of the gasification reaction vessel 11 to maintain proper fluidization and ash discharge. Most of the gasification reactions take place in the lower portion or gasification zone 14 of the gasification reaction vessel 11. A disengaging zone or product gas zone 15 is provided in the upper portion of the gasification reaction vessel 11 to facilitate the separation of solid particles from the gas stream. The product gas passes into product gas zone 15 and the ash is removed through ash outlet 21 disposed in the bottom of gasification reactor vessel 11. Fines elutriated from the fluidized bed are separated from the product gas in two stages of external cyclones 30, 31. The product gas, which comprises among other constituents hydrogen, contacts the first side 17 of permeable hydrogen-selective membrane 16, which is disposed in product gas zone 15, whereby at least a portion of the hydrogen passes through the membrane into a region of gasification reactor vessel 11 disposed on the side 18 of the membrane opposite first side 17. The hydrogen is exhausted through hydrogen gas outlet 19. Product gas unable to permeate through permeable hydrogen-selective membrane, referred to herein as retentate gas, is exhausted from product gas zone 15 through retentate gas outlet 13 for further processing.

FIG. 5 shows a membrane module 50 disposed within the disengaging or product gas zone 15 of gasification reaction vessel 11 in accordance with one embodiment of this invention. In accordance with the embodiment shown, the membrane module 50 comprises a plurality of membranes in the form of tubes 52. To protect the membrane material of membrane tubes 52 from the solid particles in the gasification reaction vessel 11, each membrane tube 52 is enclosed within a ceramic filter tube 51, as shown more clearly in FIG. 6, forming an annular space 57 between ceramic filter tube 51 and membrane tube 52. Thus, only gaseous species can enter the annular space 57. The ceramic filter tubes 51 are closed off at the bottom 58, as a result of which synthesis gas produced in the gasification zone 14 of the gasification reaction vessel 11 travels through the ceramic filter tube wall into the annular space 57. Due to the perm selective property of the membrane material, hydrogen preferentially permeates through the membrane of the membrane tube 52 into the interior thereof and flows upwards to a hydrogen plenum chamber 60 disposed at the outlet end 61 of the membrane tubes 52 before exiting the gasification reaction vessel 11 through hydrogen gas exhaust 53. The non-permeate gas or retentate is collected in a retentate plenum chamber 62 disposed below the hydrogen plenum chamber 60 and exits through side ports 54 of the gasification reaction vessel

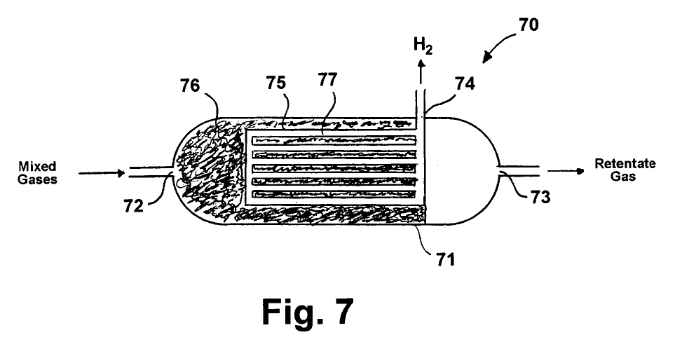

FIG. 7 shows a gas phase reactor, for example, a fuel reformer, in accordance with one embodiment of this invention comprising gas phase reactor vessel 71 having a gas inlet 72, a gas retentate outlet 73 and a hydrogen gas outlet 74. Disposed within gas phase reactor vessel 71 is a catalytic packing 76 of a catalytic material known to those skilled in the art suitable for promoting the gas phase reactions. Also disposed within gas phase reactor vessel 71 is a membrane module 75, whereby hydrogen generated during the gas phase processing, for example reforming, passes through the membrane module walls into the interior 77 of membrane module 75 and is expelled from the reactor vessel through hydrogen gas outlet 74. The reaction product gases which are prevented from permeating through the membrane module walls are expelled from the reactor vessel through retentate outlet 73.

### EXAMPLE 1

In this example, a H₂-selective membrane tube made of material of perovskite compounds is used to extract hydrogen from an Illinois #6 bituminous coal in a gasification process. The tube has an outside diameter of 1.25 cm with a wall thickness of 1 mm. The membrane tube is protected by a 2.5 cm O.D. ceramic filter tube such as the commercial candle filters made by Siemens Westinghouse. The tube has a length of 300 cm. The disengaging zone of the gasifier, which has a diameter of about 50 cm, holds 200 membrane tubes providing about 23.5 m² of total membrane area. The coal is fed to the gasifier at a rate of 1000 lbs/hr, operating at a temperature of 1800° F. (982° C.) and a pressure of 60 atm. Steam is added to the gasifier at a steam/carbon mole ratio of 1.0 and oxygen is added to the gasifier at a rate of oxygen/carbon mole ratio of 0.38. Based on the assumptions of thermodynamic equilibrium for all the chemical reactions in the system and with a membrane having a flux of about 50 cc/min/cm², hydrogen at a rate of 3140 mole per hour may be produced directly from the gasifier.

### EXAMPLE 2

In this example, a H₂-selective membrane tube made of palladium-alloy compounds is used to extract hydrogen from a Switchgrass biomass in a gasification process. The tube has an outside diameter of 1.25 cm with a wall thickness of 1 mm similar to the previous example. The tube has a length of 300 cm. The disengaging zone of the gasifier has a diameter of 34 cm and holds 100 membrane tubes providing about 11.6 m² of total membrane area. The biomass is fed to the gasifier at a rate of 1000 lbs/hr, operating at a temperature of 1500° F. (815° C.) and a pressure of 22 atm. Steam is added to the gasifier at a steam/carbon mole ratio of 0.4 and oxygen is added to the gasifier at a rate of oxygen/carbon mole ratio of 0.3. Based on the assumptions of thermodynamic equilibrium for all the chemical reactions in the system and with a membrane having a flux of about 50 cc/min/cm², hydrogen at a rate of 1550 moles per hour may be produced directly from the gasifier.

### EXAMPLE 3

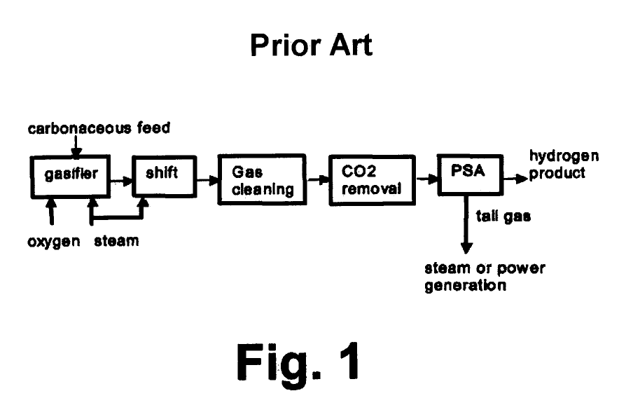

In this example, coal is gasified in a gasifier at a rate of about 100,000 lbs/hr, operating at a temperature of about 1600° F. and a pressure of about 21.4 atm. Steam is introduced into the gasifier at a steam/carbon mole ratio of 0.66 and oxygen is introduced into the gasifier at a rate of oxygen/carbon mole ratio of 0.42. Based on the assumptions of thermodynamic equilibrium for all chemical reactions in the system, calculations were performed for 4 different process schemes, 1) the conventional process without the use of hydrogen-selective membrane, as shown in FIG. 1; 2) the current invention process where a membrane is used within the gasifier and the same type of membrane is used in the shift reactor, as shown in FIG. 2; 3) the same process as shown in FIG. 2 but without the use of the membrane in the gasifier; and 4) another embodiment of the process of this invention in which the membrane gasifier of this invention is used, but no shift reaction is employed, as shown in FIG. 3. In cases where membranes are used, the flux of hydrogen is assumed to be 50 cc/min/cm² membrane area at 50 psi of hydrogen pressure gradient across the membrane and in the temperature range of 800 to 900° C.

The following Table 1 compares the results for the above 4 processes in terms of cold efficiency, which is defined as high heating value (HHV) of hydrogen product divided by the HHV of the carbonaceous feed. This measure is equivalent to the comparison of hydrogen production rate per unit mass of feed into the gasifier.

TABLE 1

| | Process | | | |
|---|---|---|---|---|
| | 1 | 2 | 3 | 4 |
| Cold gas efficiency | 53.4% | 83% | 59.3% | 62.1% |
| Gas to CO₂ removal | 4940 | 3134 | 3658 | 3949 |
| unit, kmole/hr | | | | |
| Membrane area, m² | 0/0 | 1830/608 | 0/957 | 1830/0 |
| (gasifier/shift) | | | | |

Shown in Table 1 are the amounts of gas entering into the CO₂ removal unit, which is an indication of the required equipment sizes for the downstream separation units. As can be seen, Process 2, which uses the membrane gasifier in combination with the membrane shift reactor, processes the least amount of gas in the CO₂ removal unit for a given amount of hydrogen product. The conventional process (Process 1 ) requires the largest amount of gas in the down stream separation units. Thus, the advantage of this invention can be clearly seen from its high gas efficiency and low residual gas flow to the CO₂ removal unit.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

1. An apparatus comprising:
a carbonaceous material reactor vessel having a carbonaceous material inlet, an hydrogen-rich gas outlet, a retentate gas outlet, a reaction zone containing a carbonaceous material, and a product gas zone containing reaction product gas; and
at least one permeable hydrogen-selective membrane disposed within said carbonaceous material reactor vessel and having a first side in contact with said reaction product gas and an opposite second side in contact with an hydrogen-rich gas.

2. An apparatus in accordance with claim 1, wherein said carbonaceous material reactor vessel is a gasification reactor vessel.

3. An apparatus in accordance with claim 2, wherein said at least one permeable hydrogen-selective membrane is at least one of proton conductive and electron conductive.

4. An apparatus in accordance with claim 3, wherein said at least one permeable hydrogen-selective membrane is proton conductive and electron conductive.

5. An apparatus in accordance with claim 2, wherein said permeable hydrogen-selective membrane is operable at temperatures up to at least about 2000° C.

6. An apparatus in accordance with claim 2, wherein said permeable hydrogen-selective membrane comprises a membrane material selected from the group consisting of Pd, Pd—Ag alloy, Pd—Cu alloy, perovskite-type ceramic materials, composites of Pd and ceramic materials, and combinations thereof.

7. An apparatus in accordance with claim 2, wherein said permeable hydrogen-selective membrane comprises a ceramic material of perovskite oxide having a formula
A₁₋ₓA′ₓB_{1-y}B′_{y}O_{3-z}
where A is selected from the group consisting of Ba, Sr, Ca and Mg, A′ is selected from the group consisting of La, Pr, Nd, Gd, and Yb, B and B′ are selected from the group consisting of Ce, Nd, Sm, Eu, Gd, Tm, Yb and Y, O is oxygen, x and y are numbers in a range of 0 to 1, and z is a number sufficient to neutralize a charge in said perovskite oxide.

8. An apparatus in accordance with claim 2, wherein said at least one permeable hydrogen-selective membrane is disposed within a membrane module disposed within said gasification reactor vessel.

9. An apparatus in accordance with claim 8, wherein said at least one permeable hydrogen-selective membrane is in one of a sheet form and a tubular form.

10. An apparatus in accordance with claim 6, wherein said perovskite-type ceramic material comprises an electron conductive metal.

11. An apparatus in accordance with claim 10, wherein said electron conductive metal is selected from the group consisting of Ni, Pd, Pt and combinations thereof.

12. An apparatus in accordance with claim 8, wherein a solid particle, impermeable-gas permeable protective sheath is disposed around said membrane module.

13. An apparatus in accordance with claim 2, wherein said gasification reactor vessel is a fluidized bed gasification reactor.

14. An apparatus in accordance with claim 1, wherein said carbonaceous material reactor vessel is a gas phase reactor vessel.

15. An apparatus in accordance with claim 14, wherein said at least one permeable hydrogen-selective membrane is at least one of proton conductive and electron conductive.

16. An apparatus in accordance with claim 15, wherein said at least one permeable hydrogen-selective membrane is proton conductive and electron conductive.

17. An apparatus in accordance with claim 14, wherein said permeable hydrogen-selective membrane is operable at temperatures up to at least about 2000° C.

18. An apparatus in accordance with claim 14, wherein said permeable hydrogen-selective membrane comprises a membrane material selected from the group consisting of perovskite-type ceramic materials, composites of Pd and ceramic materials, and combinations thereof.

19. An apparatus in accordance with claim 18, wherein said permeable hydrogen-selective membrane comprises a ceramic material of perovskite oxide having a formula
A₁₋ₓA′ₓB_{1-y}B′_{y}O_{3-z}
where A is selected from the group consisting of Ba, Sr, Ca and Mg, A′ is selected from the group consisting of La, Pr, Nd, Gd, and Yb, B and B′ are selected from the group consisting of Ce, Nd, Sm, Eu, Gd, Tm, Yb and Y, O is oxygen, x and y are numbers in a range of 0 to 1, and z is a number sufficient to neutralize a charge in said perovskite oxide.

20. An apparatus in accordance with claim 14, wherein said at least one permeable hydrogen-selective membrane is disposed within a membrane module disposed within said gas phase reactor vessel.

21. An apparatus in accordance with claim 20, wherein said at least one permeable hydrogen-selective membrane is in one of a sheet form and a tubular form.

22. An apparatus in accordance with claim 18, wherein said perovskite-type ceramic material comprises an electron conductive metal.

23. An apparatus in accordance with claim 22, wherein said electron conductive metal is selected from the group consisting of Ni, Pd, Pt and combinations thereof.

24. A method for producing hydrogen comprising the steps of:
introducing a carbonaceous material into a reactor vessel suitable for gasifying said carbonaceous material;
converting said carbonaceous material to a product gas comprising hydrogen and at least one of CO, CO_{2 , CH}_{4 , H}₂O and H_{2 S; and}
contacting a permeable hydrogen-selective membrane disposed within said reactor vessel with said product gas resulting in passage of at least a portion of said hydrogen through said permeable hydrogen-selective membrane, forming a hydrogen-rich gas and a non-permeate mixture.

25. A method in accordance with claim 24, wherein said conversion is carried out in a fluidized bed disposed within said reactor vessel.

26. A method in accordance with claim 24, wherein said permeable hydrogen-selective membrane is at least one of proton and electron conductive.

27. A method in accordance with claim 24, wherein said permeable hydrogen-selective membrane comprises a membrane material selected from the group consisting of Pd, Pd—Ag alloy, Pd—Cu alloy, perovskite-type ceramic materials, composites of Pd and ceramic materials, and combinations thereof.

28. A method in accordance with claim 24, wherein said reactor vessel is at a temperature in a range of about 700° C. to about 2000° C.

29. A method in accordance with claim 24, wherein said reactor vessel is at a pressure in a range of about 1 to about 200 atm.
